(19) United States
(12) Patent Application Publication
(10) Pub. No.: US 2004/0048015 A1
(43) Pub. Date: Mar. 11, 2004

(54) Use of a thermally insulating composition for insulating pipes contained in a duct transferring petroleum products

(76) Inventor: Noeelle Berger, Ecully (FR)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/415,276

(22) PCT Filed: Oct. 23, 2001
(86) PCT No.: PCT/FR01/03285

(30) Foreign Application Priority Data
Oct. 27, 2000 (FR) 00/13808

(51) Int. Cl. B32B 1/08

(52) U.S. Cl. 428/35.3

(57) ABSTRACT

The invention concerns the use of a polymerisable and injectable thermally insulating composition comprising at least a polyolidiene at least a polyisocyanate and at least an inert liquid filler for thermal insulation of pipes contained in a duct transferring petroleum products.

The present invention relates to the use of a thermally insulating composition for insulating pipes contained in a duct transferring petroleum products. More particularly, the present invention relates to the use of such a composition for insulating pipes contained in a submarine duct transferring petroleum products, in particular if this duct has been installed in the vicinity of seabeds at great depth, of a few hundred meters or more.

At these depths, submarine wells mostly produce multiphase mixtures comprising liquid and gaseous hydrocarbons and water discharged at temperatures of from 30° C. to 150° C., or indeed higher. The low temperatures prevailing at such depths can bring about the crystallization of paraffins, or more specifically of gas hydrates (methane hydrates) which can block the pipes through which they pass.

When a terrestrial oil deposit is exploited, hydrocarbons flow from the bottom of the well to the surface through a pipe termed a production string. At the bottom of the well the pressure and the temperature are relatively high, for example 100° C. and 300 bar. These pressure and temperature values decrease during the rise of the hydrocarbons toward the surface, the result being that the discharge temperature from the well is of the order of 30° C., for example.

This lowering of the temperature of the hydrocarbons in the production string has the effect of increasing the viscosity and the density of these hydrocarbons, and this can bring about slowing of their flow. However, the lowering of temperature can also sometimes, as mentioned above, cause crystallized paraffins to deposit on the wall of the production string. If this deposit accumulates in the production string it can cause serious operating problems, for example holdup of the hydrocarbons, or indeed total obstruction of the production string. The operator wishing to avoid these risks is generally obliged to deal with this deposit phenomenon, either preventatively by injecting a chemical deposition-inhibiting product or curatively by using specialized equipment to scrape or abrade the production string, or else using some available means to heat the deposit. In all cases, these operations constitute significant expense. This type of problem is also found in pipes which connect a wellhead to a distant processing unit.

There is also a risk that blockages will occur during technical stoppages in the transfer of said petroleum products.

There is a known solution for preventing the blockage of submarine pipes, by covering the pipes with an external coating adhering to the pipes, made from a thermally insulating material which also has the necessary mechanical resistance to withstand the high hydrostatic pressure prevailing at great depths. The materials used as constituents of this coating are in particular composite products based on an epoxy resin, polyurethane, or polypropylene, for example. Such products are manufactured and marketed by companies such as Isotub (France), Balmoral Webco Pipeline Systems (United Kingdom) and Bredero Price (USA), for example. Their composition can be adjusted to control their density (and therefore buoyancy), their mechanical resistance, and their coefficient of thermal conductivity, for example. The high mechanical resistance of the coating necessary at great depths is accompanied by a significant increase in the density of the material used, and this increase in density has an adverse effect on its thermal insulation properties. This then means that a further increase in the thickness of the coating is needed to obtain the required thermal insulation, making this solution too costly at great depths. In addition, the abrasion resistance of such a coating is insufficient to permit the use of towing methods for laying the resultant sheathed pipes on the seabeds.

In another known technique for ensuring the protection of submarine pipes at great depths, these pass through a traditional protective tubular sheath capable of resisting hydrostatic pressure. This sheath permits towing methods to be used for laying the resultant protected pipes. The tubular sheath can contain a number of pipes, each being coated with a low-thickness, low-density coating of thermal insulation (polyurethane foam, polyethylene foam, glass wool, rock fiber, etc.). At very great depths, the steel sheath is incapable of resisting the hydrostatic pressure unless its thickness is unreasonably increased, the result being an increase in its weight per linear meter with detriment to its buoyancy, which is necessary when towing methods are used for its laying. In this last instance moreover a known solution pressurizes the space within the sheath included between the coated pipe(s) and the sheath itself, with an inert gas such as nitrogen, for example. It is therefore necessary to maintain the pressure of nitrogen in the sheath during the entire period of operation of the pipes, which may continue for 20 years or more.

This restriction becomes costly because the initial pressurization is expensive and maintenance is difficult since nitrogen slowly diffuses through the welds of the tubular sheath. In addition, this pressure has to be established during the construction of the duct on land, for example on a beach. The high pressure to be established can then cause a dangerous explosion of the sheath. It is therefore necessary to increase the thickness of the sheath, but this impairs the buoyancy of the assembly, vital if a towing method is to be used for its laying, as stated above.

Another proposal, in the French Patent Application No. 2 769 682, concerns a submarine duct transferring petroleum products comprising at least one pipe for such products and a tubular protective sheath through which said pipe passes, this duct comprising a fill of a thermally insulating material mechanically resistant to the hydrostatic pressure of the submarine location where said duct is installed, said fill being immersed in water inside the sheath at a pressure which is the same as the external hydrostatic pressure. The reason for this is that it is known that the difference between the hydrostatic pressures acting respectively outside and inside the immersed submarine duct is proportional to the difference between the density of the surrounding seawater and the density of the fill material. If the values of this difference are high, the sheath can collapse.

The fill consists of a composite product from the family of what are known as “syntactic” products. Such products differ from the abovementioned materials in their composition, their price and their low density.

By way of example, these products consist of microspheres, and optionally of macrospheres, surrounded by a matrix consisting of an epoxy resin, polyurethane, or polypropylene.

This fill material is characterized by the fact that it acts as thermal insulation for the pipe(s) passing into the sheath, it withstands a certain external hydrostatic pressure and it provides the duct assembly with the buoyancy required during its laying.

The water used to bring the submarine duct to the same pressure as the submarine environment during its laying may be water from the submarine environment, optionally comprising a corrosion inhibitor.

Although this method of operation has advantages, the use of water has numerous disadvantages. Water is a poor thermal insulator: its thermal conductivity is high and, its viscosity being very low, it also promotes convection cooling.

In addition, syntactic foams tend to crack during laying and over time, thus creating thermal bridges and pathways for water, and thus impairing the insulating function of the foam.

The applicant proposes to use a thermally insulating composition for insulating pipes contained in a duct transferring petroleum products, and in particular having the required properties of mechanical resistance (burst strength), thermal insulation and chemical resistance (presently resistance to corrosion and hydrolysis) and also providing the necessary conditions for easy use.

More particularly, the applicant proposes to use a thermally insulating composition mechanically resistant to hydrostatic pressure to insulate pipes contained in a submarine duct transferring petroleum products, intended particularly to be installed on or in the vicinity of a seabed at great depth.

The present invention therefore provides the use of a thermally insulating composition preferably resistant to hydrostatic pressure for insulating pipes contained in a duct transferring petroleum products, preferably for insulating pipes contained in a submarine duct transferring petroleum products which is installed on or in the vicinity of a seabed at great depth, said composition being characterized in that it consists of a crosslinkable and injectable insulating composition.

The crosslinkable and injectable insulating composition according to the present invention comprises at least one diene polyol, at least one polyisocyanate of functionality≧2, optionally a crosslinking catalyst and a sufficient amount of at least one inert liquid filler to give said composition a viscosity below 500 mPa.s at the temperature at which it is used. The temperature at which said composition according to the invention is used is the temperature at which it is introduced into said (submarine) duct to provide thermal insulation of the same.

This temperature of use is at least 4° C. and can attain 45° C., or indeed a higher temperature.

According to the present invention, during the period of use of said composition its viscosity may change but must advantageously remain below about 500 mPa.s.

After crosslinking, the composition according to the present invention has the form of a non-exuding homogeneous rubbery solid.

According to the present invention, the amount used of chemically inert liquid filler will be greater than 80% and preferably between 90% and 96% of the crosslinkable insulating composition by weight.

According to the present invention, the chemically inert liquid filler is an insulating liquid capable of complete solubilization of the polydiene polyols and the polyisocyanates, chosen from alkyl-benzenes, such as decylbenzenes and dodecylbenzenes; esters, e.g. products of reaction of polyhydric alcohols, such as pentaerythritol, with monobasic carboxylic acids, such as n-heptanoic acid; alkyl phthalates, such as dibutyl phthalate and diethyl phthalate; alkylpolyaromatic compounds, such as the mixture of isomers of dibenzyltoluene (DBT), monoiso-propylbiphenyl (MIPB) and phenylxylylethanes (PXEs); mixtures of benzyltoluenes and dibenzyltoluenes, such as those in particular described in European Patent No. 136230-B1; mixtures of mono- and bis(methylbenzyl)-xylenes, such as those described in European Patent No. 0500345; mixtures of benzyltoluene and diphenylethane; naphthenic mineral oils; vegetable oils, such as colza oils and corn oils, and a combination of at least two of the abovementioned insulating liquids.

The chemically inert liquid filler used will preferably be DBT, mixtures of benzyltoluenes and dibenzyltoluenes comprising from 50% to 90% by weight of benzyltoluenes (mixture of o, m and p isomers) and from 50% to 10% by weight of dibenzyltoluenes or mixtures of isomers of mono- and bis(methylbenzyl)-xylenes.

According to the present invention, the chemically inert liquid filler has a viscosity of not more than 200 mPa.s at 20° C., preferably between 4 and 100 mPa.s, measured in accordance with the standard ASTM D 445.

According to the present invention, the polyisocyanate used may be chosen from aromatic, aliphatic or cycloaliphatic polyisocyanates, and those which contain an isocyanurate cyclic system in their molecule, having at least two isocyanate functions in their molecule, and capable of reacting with hydroxyl functions of a polyol to form a three-dimensional polyurethane network bringing about the crosslinking of the composition.

By way of illustration of aromatic polyisocyanates which can be used according to the present invention, mention will be made of diphenylmethane 4,4′-diisocyanate (MDI), polymeric MDIs, and triphenylmethane triisocyanate.

By way of illustration of an aliphatic polyisocyanate which can be used according to the present invention, mention will be made of the biuret of 1,6-diisocyanatohexane

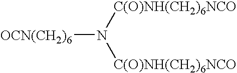

By way of illustration of cycloaliphatic polyisocyanates, mention will be made of isophorone diisocyanate (IPDI), cyclohexyl diisocyanate (CHDI), and dicyclohexylmethane 4,4′-diisocyanate.

By way of illustration of polyisocyanates which contain the isocyanurate cyclic system in their molecule, mention will be made of the trimers of hexamethylene diisocyanate marketed by RHODIA as TOLONATE HDT, tris[1-(isocyanatomethyl)-1,3,3-trimethylcyclohexane] isocyanurate marketed by HULS as VESTANAT T 1890/100.

The amount of polyisocyanate according to the present invention is chosen such that the molar NCO/OH ratio is close to 1 and preferably from 0.85 to 1.20.

According to the present invention, the polydiene polyol is a hydroxytelechelic oligomer of conjugated dienes and may be obtained by various processes, such as the free-radical polymerization of conjugated dienes having from 4 to 20 carbon atoms in the presence of a polymerization initiator, such as hydrogen peroxide or an azo compound, such as azobis-2,2-[2-methyl-N-(2-hydroxyethyl)propionamide], or the anionic polymerization of conjugated dienes having from 4 to 20 carbon atoms in the presence of a catalyst, such as dilithionaphthalene.

According to the present invention, the conjugated diene of the polydiene polyol is chosen within the group comprising butadiene, isoprene, chloroprene, 1,3-pentadiene and cyclopentadiene.

The scope of the invention includes the use of hydroxytelechelic oligomers of conjugated dienes epoxidized on the chain and the use of hydrogenated hydroxytelechelic oligomers of conjugated dienes.

According to the present invention, the polydiene polyols may have numerical molar masses of not more than 7 000 and preferably between 1 000 and 3 000. They have functionalities of from 1 to 5, preferably from 1.8 to 3, and a dynamic viscosity of not less than 600 mPa.s measured at 30° C.

By way of illustration of polydiene polyols, mention will be made of the hydroxylated polybutadienes marketed by ATOFINA as Poly Bd® R 45 HT and Poly Bd® R 20 LM.

According to the present invention, the composition may also comprise one or more low-molar-mass polyols besides the polydiene polyol.

Low-molar-mass polyol means polyols having molar masses of from 50 to 800.

By way of illustration of such polyols, mention may be made of ethylene glycol, propylene glycol, diethylene glycol, dipropylene glycol, polyether polyols, 1,4-butanediol, 1,6-hexanediol, 2-ethyl-1,3-hexanediol, N,N-bis(2-hydroxypropyl)-aniline, 3-methyl-1,5-pentanediol, trimethylolpropane, pentaerythritol, the propoxylated bisphenol A marketed by AKZO as DIANOL 320 and a mixture of at least two abovementioned polyols.

If use is made of a low-molar-mass polyol, the molar NCO/OH ratio will have to be calculated taking account of the hydroxy functions supplied by said low-molar-mass polyol.

If use is made of a crosslinking catalyst, this may be chosen within the group comprising tertiary amines, imidazoles and organometallic compounds.

By way of illustration of tertiary amines, mention may be made of diaza-1,4-bicyclo[2.2.2]octane (DABCO) and N,N,N′,N″,N″-pentamethyldiethylenetriamine.

By way of illustration of organometallic compounds, mention may be made of dibutyltin dilaurate, dibutyltin acetate, and organic derivatives of bismuth.

The crosslinkable composition of the present invention may be obtained by mixing, at ambient temperature (about 20° C.), the various constituents by any means of agitation adequate to ensure good dispersion of the constituents. The composition may comprise one or more additives, such as antioxidants and corrosion inhibitors.

The crosslinkable composition of the invention has the advantage of acting as thermal insulation for the pipe(s) passing into the duct, because it has low thermal conductivity and completely prevents convection. In addition, given its resistance to hydrostatic pressure, the composition of the present invention is very particularly used for the thermal insulation of pipes contained in a submarine duct transferring petroleum products which is installed on or in the vicinity of a seabed at great depth. This is because the crosslinkable composition of the invention has a density close to that of the seawater present at the seabeds, thus permitting the submarine duct comprising the composition to have better resistance to the hydrostatic pressure of the submarine location where said duct is installed.

The crosslinkable composition of the invention, which is liquid at the time of use, has very low shrinkage during its crosslinking, thus permitting complete “wetting” of the pipes to be jacketed. The shrinkage is less than 1% by volume, or even less than 0.5%.

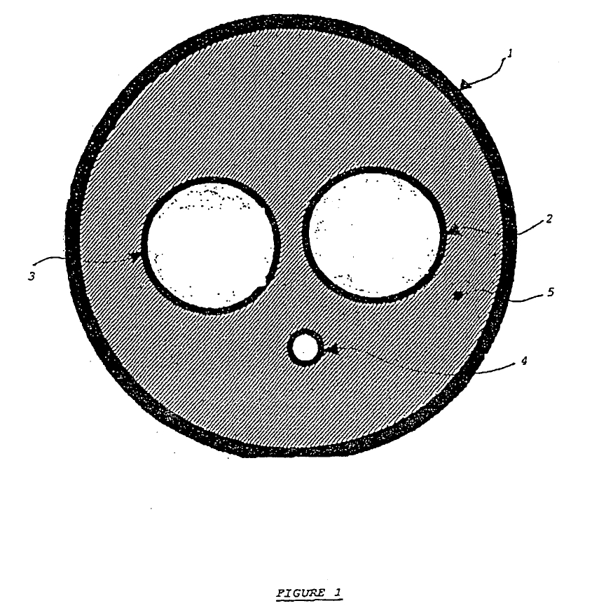

FIG. 1 is a diagrammatic cross-sectional view of a submarine duct transferring petroleum products comprising the composition of the invention.

In this FIG. 1 it is apparent that the duct shown comprises a sheath (1) which is generally of steel and may be externally coated with an anti-corrosion coating (not shown in the figure); pipes (2), (3) and (4), the pipes (2) and (3) conveying the petroleum products and the pipe (4) being what is known as a service pipe; where these pipes (2), (3) and (4) may also be externally coated with an anti-corrosion coating (not shown in the figure); (5) shows the space filled by the fill material which consists of a crosslinkable insulating composition.

The pipes (2), (3) and (4) may be arranged as desired, but preferably as close as possible to the center of the duct in which they may be held by chocks not shown in the figure.

The submarine ducts transferring petroleum products may be obtained by way of sections of a few meters in length which are generally assembled by appropriate means on a shore near the oil field site. Various methods may be used to deliver these ducts once they have been assembled. They may be delivered by a surface method, delivered between surface and seabed, or else towed on the seabed. In all cases it is necessary to adjust the buoyancy of the submarine duct to allow its transport, its immersion, and its final positioning.

For convenient control of the buoyancy of said submarine ducts, what are known as weight-reducing fillers may be incorporated into the crosslinkable insulating composition. By way of illustration of such fillers, mention will be made of cork powder, synthetic resin microbeads (of phenolic or melamine-formol type), hollow carbon microspheres, glass microspheres (silica or sodium borosilicate), and graded fly-ash. The last will preferably be used because it has good crush resistance.

The crosslinkable insulating composition of the present invention may be put in place by any appropriate means.

In one particular embodiment of the invention in particular it is possible to inject, into a section, a crosslinkable composition which has been previously prepared and has sufficient fluidity to permit total filling of said section comprising the pipe(s). It is preferable for the composition to have a viscosity below 200 mPa.s at the temperature of use, which is not more than 45° C.

Said composition is then crosslinked.

The setting time, which is the time necessary for the composition according to the present invention to become completely crosslinked, may vary widely. However, this setting time must be adjusted so that the composition according to the present invention can completely fill the (submarine) duct and can completely wet the pipe(s) inside said duct to ensure their insulation.

The person skilled in the art will therefore adjust the proportions of the constituents of said composition and, optionally, the amounts of crosslinking catalyst to be used, to obtain the appropriate setting time.

The crosslinkable composition of the invention has the advantage of adaptability to the various instances mentioned above.

The composition of the present invention may also be used to complete the thermal insulation of pipes already comprising a primary coating of insulation.

We give below some examples in which crosslinkable compositions which can be used according to the present invention are obtained.

The compositions were prepared using the following constituents:

PolyBd® R 45 HT (hereinafter termed PolyBd): hydroxylated polybutadiene with Mn of 2 800 (determined by steric exclusion chromatography) having a hydroxyl index I_{OH} expressed in milliequivalent per gram (meq/g) of 0.83, a viscosity of 5 000 mPa.s at 30° C. and a density of 0.90,

JARYTERM BT06 marketed by ATOFINA (hereinafter BT06): chemically inert liquid filler consisting of 75% by weight of benzyltoluenes and 25% by weight of dibenzyltoluenes having a viscosity of 6.5 mPa.s at 20° C. measured in accordance with the standard ASTM D 445,

JARYTHERM AX320 marketed by ATOFINA (hereinafter XX): chemically inert liquid filler comprising a mixture of mono- and bis(methylbenzyl)-xylenes having a viscosity of 21.6 mPa.s at 20° C. measured in accordance with the standard ASTM D 445,

JARYTHERM DBT marketed by ATOFINA (hereinafter DBT): chemically inert liquid filler comprising a mixture of isomers of dibenzyltoluene having a viscosity of 55 mPa.s at 20° C. measured in accordance with the standard ASTM D 445,

Tolonate HDT (hereinafter Tolonate): tris(6-isocyanatohexyl) isocyanurate, having NCO content of 22%, functionality of about 3.4 and a viscosity of 2 400 (+/−400) mPa.s at 25° C.,

Voranol CP 455 marketed by DOW CHEMICAL (hereinafter Voranol): polyether polyol of molar mass 450 having an I_{OH} of 6.77 meq/g and a viscosity of 330 mPa.s at 25° C.,

Isonate M 143 (hereinafter Isonate) marketed by DOW CHEMICAL: polymeric MDI having NCO content of 30%, functionality of 2.2 and a viscosity of 130 mPa.s at 20° C.,

dibutyltin dilaurate (crosslinking catalyst) hereinafter DBTL.

The compositions may be obtained in accordance with the specification below which consists in separately preparing a first mixture A comprising at least one inert liquid filler and at least one di- or polyisocyanate and a second portion B comprising at least one diene polyol and optionally a polycondensation accelerator, hereinafter catalyst, so as to obtain a molar NCO/OH ratio of from 0.85 to 1.20.

A and B are then mixed in a device ensuring good mixing of the 2 portions (such as a static mixer), and the compositions are then held at ambient temperature (20° C.), and the viscosity is recorded as a function of time.

Another method of preparing the compositions of the invention consists in simultaneously mixing the various constituents with the aid of a device ensuring good mixing of the constituents, the compositions being held, as above, at ambient temperature, and the viscosity being recorded as a function of time.

The setting time Tp expressed in days or in hours is noted and corresponds to the juncture at which the composition is completely crosslinked.

Viscosity measurements were also made as a function of time, as were setting time Tp measurements at temperatures above ambient temperature.

Table 1 indicates the constituents—nature and percentage (expressed by weight)—of the compositions, the setting time Tp at a given temperature and the cross-reference to the graphs indicating the viscosity (in mPa.s) as a function of time at a given temperature T in ° C.

TABLE 1

| | CONSTITUENTS | | | | | | | | | | | | |
|---|---|---|---|---|---|---|---|---|---|---|---|---|---|
| Crosslinkable | DBT | BT06 | XX | Poly Bd | Voranol | Tolonate | Isonate | DBTL | | Tp | | | Graphs |
| composition | (%) | (%) | (%) | (%) | (%) | (%) | (%) | (ppm) | NCO/OH | time* | | at . . . ° C. | 9[T (° C.) ]** |
| 1 | 93.55 | | | 5.48 | | 0.97 | | | 1.1 | 60 | d | 20 | 1 T(20) |
| | | | | | | | | | | 25 | d | 40 | 2T(40) |
| 2 | 93.55 | | | 5.48 | | 0.97 | +500 | 1.1 | ˜15 | h | 20 | — | |
| 3 | | 90.06 | | 7.79 | 0.65 | | 1.50 | | 0.92 | 15 | d | 20 | 3 T(20) |
| 4 | | 94 | | 5.22 | | 0.78 | | | 0.95 | 28 | d | 40 | 4 T(40) |
| 5 | | 94 | | 5.22 | | 0.78 | | +10 | 0.95 | 6 | d | 40 | 5 T(40) |
| 6 | | 94 | | 5.22 | | 0.78 | | +20 | 0.95 | 3.5 | d | 40 | 6 T(40) |
| 7 | | | 91.63 | 7.12 | 1.25 | | +500 | 1.1 | 2 | h | 20 | 7 T(20) | |
| 8 | | | 91.63 | 7.12 | 1.25 | | +100 | 1.1 | 3.2 | h | 20 | 8 T(20) | |

*d = days, h = hours
** = T(° C.) indicates the temperature in ° C. at which the viscosity was measured as a function of time.

[image]

[image]

[image]

[image]

On these graphs we have given the viscosity of the compositions in mPa.s on the ordinate and the time in days (graphs 1 to 6) and in hours (graphs 7 and 8) on the abscissa.

The initial viscosity of a composition at a given temperature may be noted on these graphs.

Table 2 indicates the density in g/cm³ at 20° C., the conductivity in W/m.K at 20° C. and the specific heat (kJ/kgK) of the crosslinkable compositions at 20° C. and the shrinkage after crosslinking in % by volume. It should be noted that the specific heat of water at 20° C. is 4.18 kJ/kgK and that its thermal conductivity, again at 20° C., is 0.59 W/m.K.

TABLE 2

Compositions

| | 1 | 4 | 7 |
|---|---|---|---|
| Density | 1.03 | 1.00 | 0.99 |
| (g/cm³) | | | |
| Thermal conductivity | 0.13 | 0.13 | 0.16 |
| (W/m · K) | | | |
| Specific heat | 1.6 | 1.6 | 1.9 |
| (kJ/kgK) | | | |
| Shrinkage (%) | 0.24 | 0.23 | 0.26 |

The invention is not restricted to the thermal protection of pipes such as those referenced (2), (3) and (4) in FIG. 1.

It also extends to ducts comprising any number of pipes and of service lines, where these may in addition comprise lines for supply of energy, of various fluids, such as water and gas, and control lines from heads of wells installed on the seabed.

It also extends to ducts used to raise said petroleum products from the seabed to floating or semisubmersible (surface) structures, in particular to a floating production, storage and off-loading (F.P.S.O.) center, and to production strings from the bottom of a terrestrial well to the surface.

1. The use of a thermally insulating composition for insulating pipes contained in a duct transferring petroleum products; said composition being characterized in that it consists of a crosslinkable and injectable insulating composition comprising at least one diene polyol, at least one polyisocyanate of functionality≧2, optionally a crosslinking catalyst and a sufficient amount of at least one inert liquid filler to give said composition a viscosity below 500 mPa.s at the temperature at which it is used.

2. The use of a thermally insulating composition resistant to hydrostatic pressure for insulating pipes contained in a submarine duct transferring petroleum products which is installed on or in the vicinity of a seabed at great depth, said composition being characterized in that it consists of a crosslinkable and injectable insulating composition comprising at least one diene polyol, at least one polyisocyanate of functionality≧2, optionally a crosslinking catalyst and a sufficient amount of at least one inert liquid filler to give said composition a viscosity below 500 mPa.s at the temperature at which it is used.

3. The use as claimed in claim 1 or 2, characterized in that the amount used of chemically inert liquid filler is greater than 80% of the composition by weight.

4. The use as claimed in claim 3, characterized in that the amount used of chemically inert liquid filler is between 90% and 96% of the composition by weight.

5. The use as claimed in claim 3 or 4, characterized in that the chemically inert liquid filler is an insulating liquid chosen from alkyl-benzenes, dielectric esters, alkylpolyaromatic compounds, alkyl phthalates, mixtures of benzyltoluenes and dibenzyltoluenes, mixtures of mono- and bis(methyl-benzyl)xylenes, mixtures of benzyltoluenes and diphenylethane, vegetable oils, and naphthenic oils, or a combination of at least two of the abovementioned insulating liquids.

6. The use as claimed in claim 5, characterized in that the chemically inert liquid filler has a viscosity of not more than 200 mPa.s at 20° C., preferably between 4 and 30 mPa.s, measured in accordance with the standard ASTM D 445.

7. The use as claimed in claim 5 or 6, characterized in that the chemically inert liquid filler is a mixture of benzyltoluenes and dibenzyl toluenes comprising from 50% to 90% by weight of benzyltoluenes (mixture of o, m and p isomers) and from 50% to 10% by weight of dibenzyltoluenes.

8. The use as claimed in claim 7, characterized in that the chemically inert liquid filler is a mixture comprising 75% by weight of benzyltoluenes and 25% by weight of dibenzyltoluenes.

9. The use as claimed in claim 5, characterized in that the inert liquid filler is a mixture of isomers of dibenzyltoluene.

10. The use as claimed in claim 5, characterized in that the inert liquid filler is a mixture of isomers of mono- and bis(methylbenzyl)-xylenes.

11. The use as claimed in claim 1 or 2, characterized in that the polydiene polyol is a hydroxytelechelic oligomer of a conjugated diene.

12. The use as claimed in claim 11, characterized in that the conjugated diene is butadiene.

13. The use as claimed in any of claims 1, 2 and 11, characterized in that the polydiene polyol has a numerical molar mass of not more than 7 000 and preferably between 1 000 and 3 000.

14. The use as claimed in any of claims 1, 2 and 11, characterized in that the polydiene polyol has a functionality of from 1 to 5, preferably from 1.8 to 3.

15. The use as claimed in claim 1 or 2, characterized in that the polyisocyanate contains an isocyanurate cyclic system in its molecule.

16. The use as claimed in claim 15, characterized in that the polyisocyanate is tris[1-(isocyanatomethyl)-1,3,3-trimethylcyclohexane] isocyanurate or the trimer of hexamethylene diisocyanate.

17. The use as claimed in claim 1 or 2, characterized in that the polyisocyanate is an aromatic polyisocyanate.

18. The use as claimed in claim 17, characterized in that the polyisocyanate is diphenyl-methane 4,4′-diisocyanate (MDI) or a polymeric MDI.

19. The use as claimed in claim 1 or 2, characterized in that the polyisocyanate is a cyclo-aliphatic polyisocyanate.

20. The use as claimed in claim 19, characterized in that the polyisocyanate is dicyclo-hexylmethane 4,4′-diisocyanate.

21. The use as claimed in claim 1 or 2, characterized in that the composition also comprises one or more low-molar-mass polyols.

22. The use as claimed in claim 21, characterized in that the polyol has a molar mass of from 50 to 800.

23. The use as claimed in any one of claims 1 to 22, characterized in that the molar NCO/OH ratio is close to 1 and preferably from 0.85 to 1.20.

24. The use as claimed in any one of claims 1 to 23, characterized in that the insulating composition comprises a crosslinking catalyst.

25. The use as claimed in claim 24, characterized in that the crosslinking catalyst is dibutyltin dilaurate.

26. The use as claimed in any one of claims 1 to 25, characterized in that the crosslinked insulating composition has volume shrinkage of less than 1%.

27. A submarine duct for transferring petroleum products, comprising at least one pipe (2, 3), for such products, optionally at least one pipe termed a service pipe (4), a tubular protective sheath (1) through which said pipes pass and a fill of a thermally insulating material mechanically resistant to the hydrostatic pressure of the submarine location where said duct is installed; characterized in that the thermally insulating material consists of a crosslinkable and injectable insulating composition as claimed in any one of claims 1 to 26.
